(19) United States
(12) Patent Application Publication
(10) Pub. No.: US 2015/0075624 A1
(43) Pub. Date: Mar. 19, 2015

(54) TELESCOPIC DRAIN HOSE ASSEMBLY

(71) Applicant: Tompkins Industries, Inc., Olathe, KS (US)

(72) Inventors: Michael P Mahaffa, Goshen, IN (US); Jonathan David Marshman, Belton, MO (US); Dan Turnbull, Lenexa, KS (US)

(21) Appl. No.: 14/489,139

(22) Filed: Sep. 17, 2014

Related U.S. Application Data
(60) Provisional application No. 61/878,961, filed on Sep. 17, 2013.

(51) Int. Cl. F16L 37/248; B67D 7/00; F16L 11/14

(52) U.S. Cl. CPC F16L 37/248; F16L 11/14; B67D 7/002
USPC 137/1; 138/109

(57) ABSTRACT

A telescopic drain hose assembly. The assembly includes a drain conduit having a tank coupler coupled to a first end and an end piece coupled to a second end. The tank coupler is configured for coupling to a grey or black waste discharge port, such as that of a recreational vehicle. The endpiece includes coupling elements for coupling with a pipe elbow or similar attachment. A handle is provided on the endpiece for positioning the endpiece in proximity to a waste receptacle port. The drain conduit is disposed within an outer housing comprised of a telescopic tube and a flexible sleeve. The flexible sleeve is adjacent the first end of the drain conduit and enables flexure or bending of the assembly.

### CROSS-REFERENCE TO RELATED APPLICATIONS

This application claims the benefit of U.S. Provisional Patent Application No. 61/878,944 filed Sep. 17, 2013 and titled Telescopic Drain Hose Assembly, the disclosure of which is hereby incorporated herein, in its entirety, by reference.

### BACKGROUND

Recreational vehicles (RVs), mobile homes, busses, trailers, boats, and a variety of other vehicles and temporary living quarters often provide kitchen, bath, and restroom facilities. These facilities include sinks, showers, and commodes that produce liquid and solid waste that is stored in waste collection tanks or vessels within the vehicle or living quarters. The waste materials are typically divided into grey waste, which includes waste from sinks and showers, and black waste, which includes commode waste. These waste materials must be discharged or drained from the collection tanks from time to time.

Draining the tanks typically comprises attaching a flexible hose or conduit between a discharge pipe on the vehicle and a port for a waste receptacle that is often buried underground. Handling of the hose generally requires a user to wear protective gloves and to use caution to avoid contact with the black waste being discharged therethrough because of health hazards associated therewith. Such handling can be problematic due to the flexibility and resiliency of the hose which can become dislodged from the waste receptacle port and/or spring toward a normal orientation thereby slinging waste material in an unwanted direction. It is also preferable to maintain the hose with a downward slope between the vehicle discharge pipe and waste receptacle port to aid flow therethrough. This may require a user to hold the hose during emptying of the waste materials or to employ additional components to properly position the hose.

There is a need for an easily positionable drain hose that is self-supporting and that avoids user exposure to the waste materials flowing therethrough.

### SUMMARY

Embodiments of the invention are defined by the claims below, not this summary. A high-level overview of various aspects of the invention are provided here for that reason, to provide an overview of the disclosure, and to introduce a selection of concepts that are further described in the Detailed-Description section below. This summary is not intended to identify key features or essential features of the claimed subject matter, nor is it intended to be used as an aid in isolation to determine the scope of the claimed subject matter. In brief, this disclosure describes, among other things, a telescopic drain hose assembly useable to aid emptying of waste holding tanks, such as black and grey waste holding tanks in a recreational vehicle into waste receptacles or sewage systems for disposal thereof.

The drain hose assembly includes a flexible, extensible drain hose or conduit coupled to a tank coupler at a first end and to an endpiece at a second end. The hose is disposed within an outer body that is comprised of a flexible sleeve and a telescopic tube. The sleeve extends between the tank coupler and the telescopic tube to enable bending of the drain hose assembly along the sleeve and about a coupling with a discharge outlet. The telescopic tube provides a rigid portion that supports the hose between the sleeve and the endpiece. The endpiece includes a handle for easy handling of the assembly and includes surface features for coupling to one or more attachments, such as an elbow, nozzle, extension, or the like.

In use, the drain hose assembly provides a user with an drain hose that can be flexed about its coupling with a discharge outlet and can be extended to a desired length for discharging fluids and waste materials into a waste receptacle. The drain hose assembly can be manipulated without contact between the user and the waste materials and the rigid telescopic tube supports the hose without the necessity for additional components.

### DESCRIPTION OF THE DRAWINGS

Illustrative embodiments of the invention are described in detail below with reference to the attached drawing figures, and wherein:

FIG. 1 is a perspective view of a drain hose assembly depicted in accordance with an embodiment of the invention;

FIG. 2 is an exploded view of the drain hose assembly of FIG. 1;

FIG. 3 is a cross-sectional elevational view of the drain hose assembly of FIG. 1;

FIG. 4 is an illustrative view of a drain hose assembly coupled to a discharge outlet of a recreational vehicle depicted in accordance with an embodiment of the invention;

FIG. 5 is another illustrative view of the drain hose assembly depicted in FIG. 4; and

FIG. 6 is an enlarged illustrative view of the coupling of the drain hose assembly of FIG. 4 coupled to the discharge outlet of a recreational vehicle.

### DETAILED DESCRIPTION

The subject matter of select embodiments of the invention is described with specificity herein to meet statutory requirements. But the description itself is not intended to necessarily limit the scope of embodiments of the invention. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

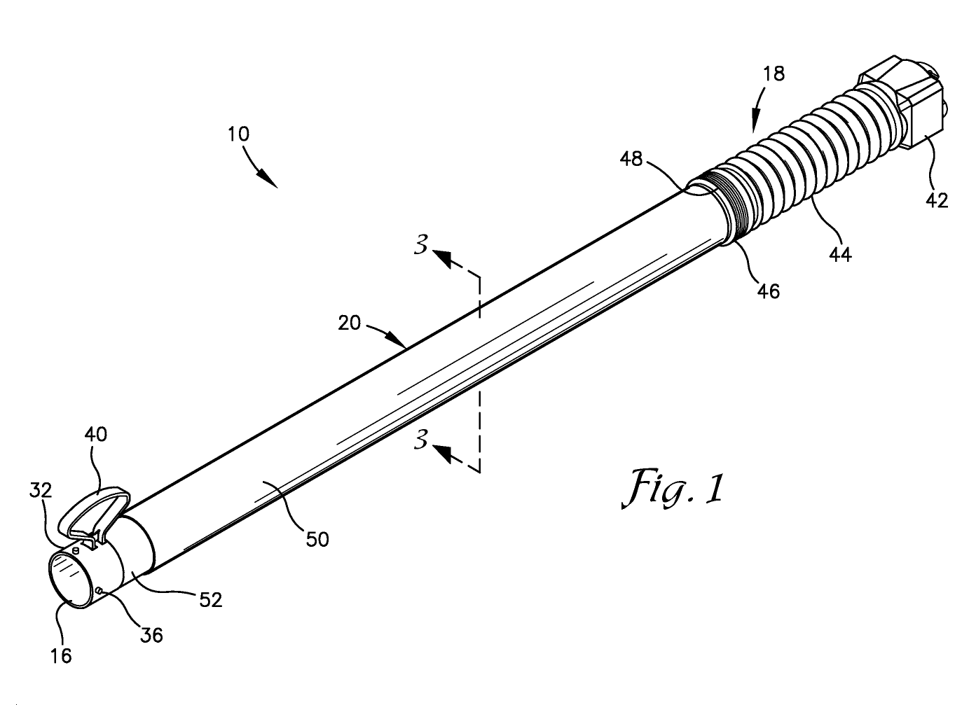

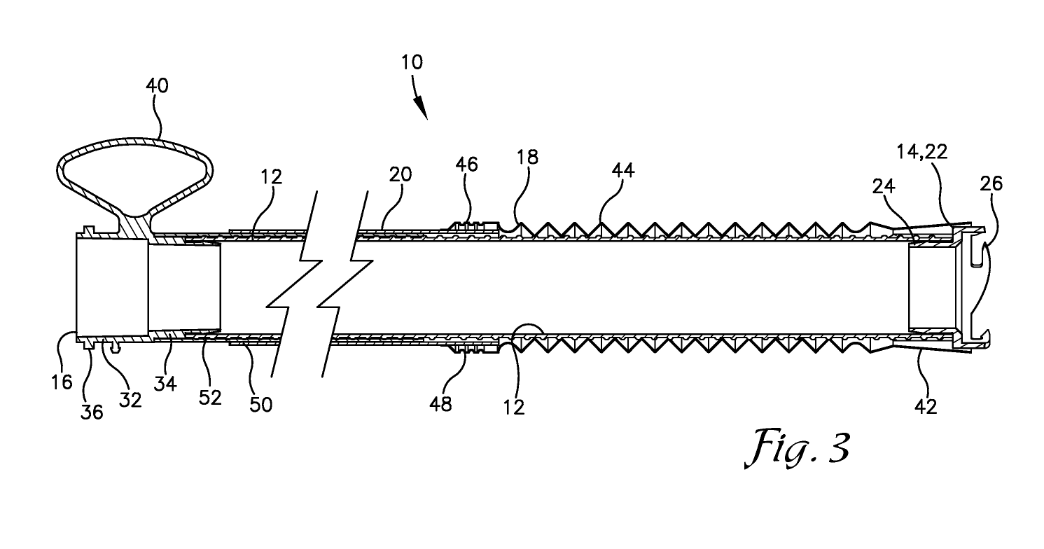

With initial reference to FIGS. 1-3, a drain hose assembly 10 is described in accordance with an embodiment of the invention. The drain hose assembly 10 is described herein with respect to its use and application with a recreational vehicle (RV), but such is not intended to limit embodiments of the invention to such applications. The assembly 10 might be employed for use with mobile homes, busses, trailers, boats, or similar vehicles containing waste holding tanks, or with any variety of other vessels that might employ the assembly 10 for draining thereof.

The drain hose assembly 10 comprises a conduit or hose 12, a tank coupler 14, an endpiece 16, a sleeve 18, and a telescopic tube 20. The hose 12 is a conventional sewage hose that is flexible and extensible in length but is generally rigid in cross-section to prevent collapsing thereof. The hose 12 may be comprised of a metallic coil encased in a plastic material to provide an accordion-like body. The hose 12 is liquid- and air-tight.

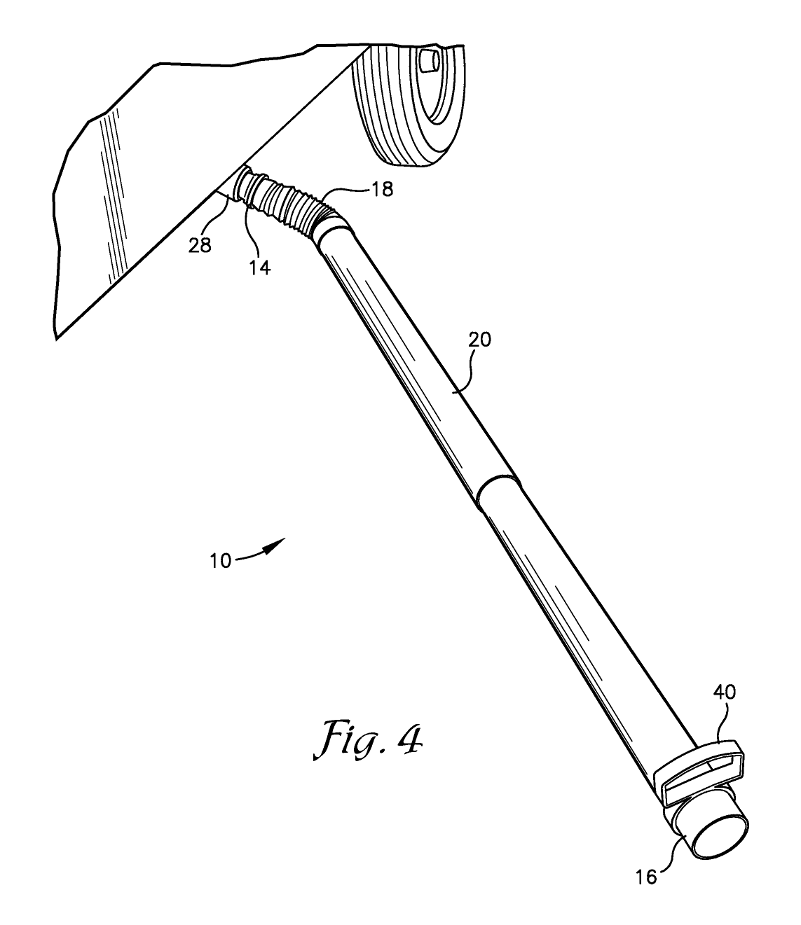

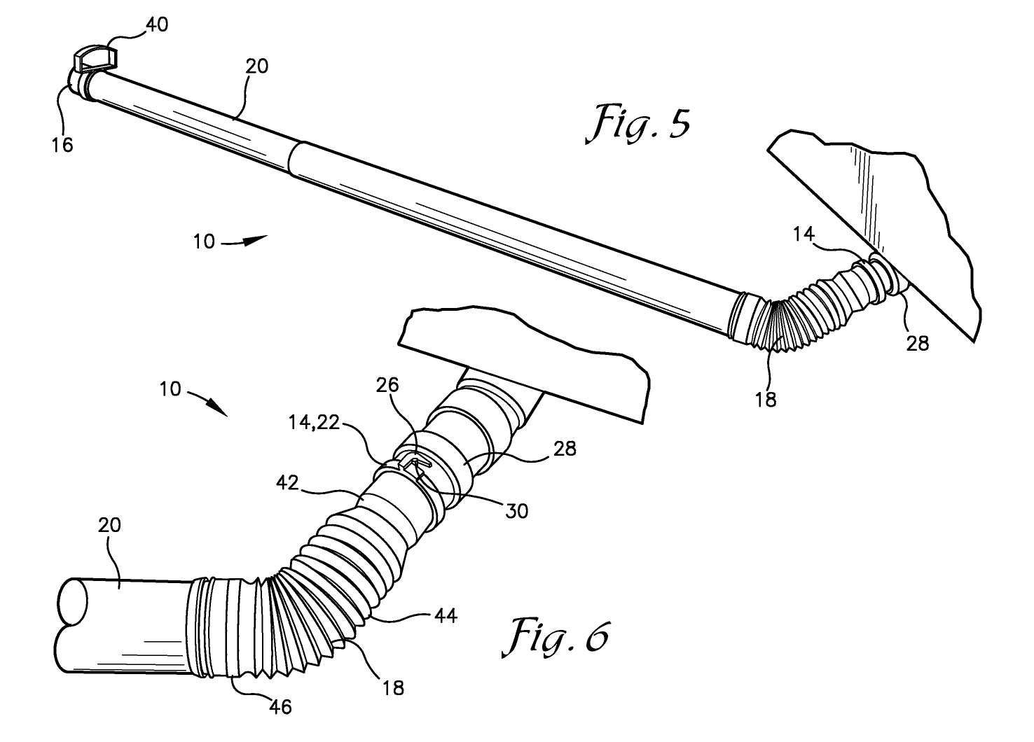

A first end of the hose 12 is coupled to the tank coupler 14 using one or more of a glue, adhesive, welding, hose clamp, or the like. The tank coupler 14 includes a body 22 having a bore therethrough with an annular flange 24 extending from a first end and dimensioned to receive the first end of the hose 12 and plurality of engaging members 26 disposed about a second end thereof. The engaging members 26 are configured to mateably couple with a discharge port 28 of a waste holding tank, such as a black or grey waste tank of an RV. As depicted in FIGS. 1-6, the engaging members 26 comprise arms configured to form a bayonet-style coupling with a plurality of nubs 30 (FIG. 6) on the discharge port 28, however any available form of coupling can be employed in embodiments of the invention without departing from the scope described herein.

A second end of the hose 12 is coupled to the endpiece 16 using one or more of a glue, adhesive, welding, hose clamp, or the like. The endpiece 16 is comprised of a hollow body 32 having a bore extending therethrough. A proximate end of the endpiece 16 forms an annular flange 34 for receiving the second end of the hose 12. A plurality of coupling elements 36 are disposed about a distal end of the endpiece 16 for coupling with an attachment (not shown), such as a pipe elbow, a nozzle, an extension, a secondary hose, or the like. The coupling elements 36 comprise nubs disposed about the outer surface of the body 32 for engaging mating elements on an attachment in a bayonet-style engagement. Or the coupling elements 36 can comprise flanges, ribs, ridges, threads, slots, or another surface feature for providing a coupling with the attachment.

The endpiece 16 includes a handle 40 extending from the body 32 and coupled thereto or integrated therewith. The handle 40 may be pivotable about its coupling with the endpiece 16 to lie generally flat thereagainst for storage and may be rotatable about an axis extending radially outward from the body 32 to provide a user with a comfortable orientation. As depicted in FIGS. 1-5, the handle 40 comprises a looped form, but the handle can be provided in any desired graspable configuration.

The hose 12 is disposed within an outer body formed by the sleeve 18 and the telescopic tube 20. The sleeve 18 encloses the first end of the hose 12 and includes a proximate end section 42, a flexible section 44, and a distal end section 46.

The proximate end section 42 is coupled to the tank coupler 14 using one or more of adhesives, glues, welding, fasteners, clamps, or the like. The proximate end section 42 is substantially rigid and encloses the coupling between the hose 12 and the tank coupler 14. The flexible section 44 is configured to enable flexure thereof and of the hose 12 disposed therein. The distal end section 46 is configured for receipt by the telescopic tube 20 and for coupling thereto. A plurality of surface features 48 are provided on a surface of the distal end section 46, such as threads, ribs, or the like for coupling to mating features on the telescopic tube 20. Or one or more glues, adhesives, fasteners, or the like can be employed to couple the distal end section 46 to the telescopic tube 20.

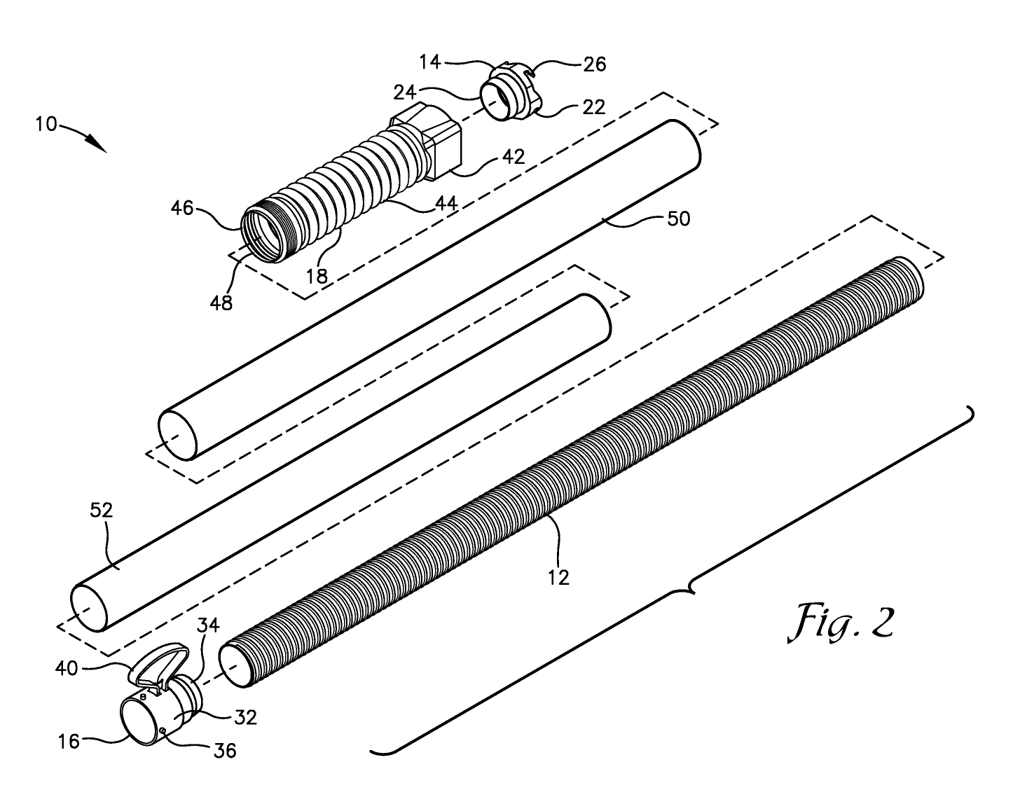

As depicted in FIG. 2, the telescopic tube 20 is comprised of an outer tube 50 and an inner tube 52, however any number of tubes can be employed to provide a desired maximum and minimum telescoping length of the telescopic tube 20. The outer and inner tubes 50, 52 are substantially rigid, non-flexible cylindrical tubes having dimensions configured to receive the hose 12 within the inner tube 52 and to receive the inner tube 52 and the hose 12 within the outer tube 50.

The inner and outer tubes 52, 50 may include obstructing surface features, such as opposing annular flanges or other surface features (not shown) on opposing surfaces thereof that resist the removal of the inner tube 52 from within the outer tube 50. Or the inner and outer tubes 52, 50 may include a frusto-conical configuration in which a maximum diameter of the inner tube 52 is greater than a minimum diameter of the outer tube 50 such that inner tube 52 cannot pass completely through the outer tube 50.

A proximate end of the outer tube 50 is coupled to the distal end section 46 of the sleeve 18 and a distal end of the inner tube is coupled to the endpiece 16. The endpiece 16 may include one or more surface features for coupling to the inner tube 52 or the endpiece 16 and inner tube 52 may be coupled via one or more glues, fasteners, clamps, or the like. As such, the hose 12 is enclosed by the telescopic tube 20 and sleeve 16 and between the tank coupler 14 and the endpiece 16.

With continued reference to FIGS. 1-6, operation of the drain hose assembly 10 is described in accordance with an embodiment of the invention. The assembly 10 may initially be collapsed or the telescopic tube 20 may be moved to a minimum length for storage. The minimum length may be configured to fit within a standard size compartment on an RV, or similar vehicle, associated with a waste collection tank system. A cap or plug is removed from the discharge port 28 of the RV and the waste collection system readied for dumping or emptying. The tank coupler 14 is coupled to the discharge port 28, such as by engaging the engaging members 26 with the nubs 28 on the discharge port 28 and rotating to provide a bayonet-style engagement therebetween.

The handle 40 is used to extend or telescope the assembly 10 to extend from the discharge port 28 to a port on a waste receptacle into which to discharge the waste materials. The handle 40 may also be used to pivot or bend the assembly 10 along the flexible section 44 of the sleeve 18 in order to align the assembly 10 with the port. The hose 12 remains contained within the assembly 10 and is extended and flexed along with the telescopic tube 20 and the sleeve 18, respectively.

An attachment, such as an elbow pipe fitting, may be connected to the endpiece 16 to aid directing of the waste materials into the port of the waste receptacle. The endpiece 16 or the attachment is positioned appropriately to discharge into the port and the waste collection tank is emptied in a conventional manner.

Accordingly, the user can handle the assembly 10 using handle 40 which is disparate from an open end of the endpiece 16 and is positioned away from any waste materials discharged therethrough. The user is thus distanced from contact with the waste materials and can operate the assembly without protective gloves or the like. Additionally, the rigidity of the telescopic tube 20 supports the hose 12 therein in a constant downward sloping orientation between the discharge port 28 and the port of the waste receptacle without the need for additional components or the user to hold the hose 12 in such an orientation. The rigidity of the telescopic tube 20 may also resist movement of the endpiece 16 out of engagement with the port of the waste receptacle as waste materials flow therethrough.

Upon completion of discharging the waste materials from the waste collection tank, the handle 40 may be employed to withdraw the inner tube 52 into the outer tube 50 to reduce the assembly 10 to a minimum length. The tank coupler 14 is uncoupled from the discharge port 28 and the assembly stored as desired.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A drain hose assembly for draining a waste collection tank, the assembly comprising:
a telescopic tube including at least an outer section and an inner section that are nested to be longitudinally extensible;
an endpiece coupled to a distal end of the telescopic tube;
a flexible sleeve coupled to a proximal end of the telescopic tube;
a flexible and extensible conduit disposed at least partially within the telescopic tube.

2. The drain hose assembly of claim 1, further comprising:
a tank coupler coupled to a first end of the sleeve.

3. The drain hose assembly of claim 2, wherein a proximate end of the conduit couples to the tank coupler.

4. The drain hose assembly of claim 1, further comprising:
a handle coupled to the endpiece.

5. The drain hose assembly of claim 1, wherein the waste collection tank is one or more of a grey or black waste collection tank.

6. The drain hose assembly of claim 1, wherein the tank coupler provides a bayonet-style coupling with a discharge port associated with the waste collection tank.

7. The drain hose assembly of claim 1, wherein the endpiece includes one or more coupling elements configured to couple an attachment with the endpiece.

8. The drain hose assembly of claim 1, wherein the tank coupler is coupled to a discharge port associated with the waste collection tank and the telescopic tube is extended to place the endpiece in close proximity to a waste receptacle.

9. The drain hose assembly of claim 1, wherein the tank coupler is coupled to a discharge port associated with the waste collection tank and wherein the assembly is pivoted relative to the discharge port to bend the assembly along the sleeve.

10. The drain hose assembly of claim 1, wherein the telescopic tube is substantially rigid and supports the conduit in a linear orientation between the sleeve and the endpiece.

11. A drain hose assembly for draining a waste collection tank, the assembly comprising:
a flexible and extensible conduit;
a tank coupler coupled to a first end of the conduit;
an endpiece coupled to a second end of the conduit;
a handle coupled to the endpiece;
a flexible sleeve, the first end of the conduit disposed in the sleeve, and the sleeve coupled to the tank coupler;
a telescopic tube, at least a portion of the conduit disposed within the telescopic tube, a first end of the telescopic tube coupled to the sleeve, and a second end of the telescopic tube coupled to the endpiece.

12. The drain hose assembly of claim 11, wherein the waste collection tank is one or more of a grey or black waste collection tank.

13. The drain hose assembly of claim 11, wherein the telescopic tube is substantially rigid and supports the conduit in a linear orientation between the sleeve and the endpiece.

14. The drain hose assembly of claim 11, wherein the endpiece includes one or more coupling elements configured to couple an attachment with the endpiece.

15. The drain hose assembly of claim 11, wherein the handle is pivotal about one or more axis.

16. The drain hose assembly of claim 11, wherein the tank coupler is coupled to a discharge port associated with the waste collection tank and the telescopic tube is extended to place the endpiece in close proximity to a waste receptacle.

17. The drain hose assembly of claim 11, wherein the tank coupler is coupled to a discharge port associated with the waste collection tank and the assembly is pivoted relative to the discharge port to bend the assembly along the sleeve.

18. A method for discharging waste materials from a waste collection tank of a recreational vehicle (RV) into a waste receptacle, the method comprising:
providing a drain hose assembly that includes a flexible sleeve, a telescopic tube coupled to the sleeve, a flexible and extensible conduit disposed within the telescopic tube, a tank coupler coupled to a first end of the sleeve, and an endpiece coupled to a second end of the telescopic tube;
coupling the tank coupler to a discharge port associated with the waste collection tank;
extending the telescopic tube and bending the assembly along the sleeve to align the endpiece with a port on the waste receptacle;
discharging the waste materials through the assembly into the waste receptacle.

19. The method of claim 18, wherein the drain hose assembly further comprises a handle coupled to the endpiece.

20. The method of claim 19, wherein the handle is pivotable about one or more axis.
